(19) United States
(12) Patent Application Publication
(10) Pub. No.: US 2015/0258911 A1
(43) Pub. Date: Sep. 17, 2015

(54) HYBRID VEHICLE

(71) Applicant: Yoshinobu SUGIYAMA, (US)

(72) Inventor: Yoshinobu Sugiyama, Toyota-shi (JP)

(73) Assignee: TOYOTA JIDOSHA KABUSHIKI KAISHA, Toyota-shi, Aichi-ken (JP)

(21) Appl. No.: 14/436,992

(22) PCT Filed: Jan. 21, 2014
(86) PCT No.: PCT/IB2014/000052

§ 371 Date: Apr. 20, 2015

(30) Foreign Application Priority Data
Jan. 25, 2013 (JP) 2013-011800

(51) Int. Cl. B60L 11/18

(52) U.S. Cl. CPC B60L 11/1862; B60L 11/1811; Y10S 903/903

(57) ABSTRACT

A hybrid vehicle includes a power storage device, a power generation unit, and a control device. The power storage device stores electric power for driving the vehicle. The power generation unit charges the power storage device. The control device is configured to set a target state of charge of the power storage device based on a scheduled non-use period set by the user, and control the power generation unit so as to adjust the state of charge of the power storage device to the target state of charge.

### BACKGROUND OF THE INVENTION

1. Field of the Invention

The invention relates to a hybrid vehicle.

2. Description of Related Art

Japanese Patent Application Publication No. 2010-183758 (JP 2010-183758 A) discloses a control device of a vehicle including a power storage device and a charging device that charges the power storage device. If the vehicle is left unattended or abandoned for a long period of time, electric power stored in the power storage device is gradually reduced due to natural discharge, for example. The vehicle is equipped with a non-use switch with which the user conveys his/her intention to leave the vehicle unattended for a long period of time, to the vehicle. When the non-use switch is in the ON state, the control device controls the charging device so as to increase the SOC (State Of Charge) of the power storage device. With this arrangement, sufficient electric power is ensured, and the vehicle can be left unattended for a prolonged period of time (see JP 2010-183758 A).

In the vehicle as described above, when the non-use switch is in the ON state, the SOC of the power storage device is uniformly increased by generating electric power using driving force of the engine. However, if the SOC of the power storage device is uniformly increased, the amount of electric power stored in the power storage device may be increased to a greater amount than necessary. In this case, the power storage device is excessively charged; therefore, electric power may be wastefully generated using the driving force of the engine.

### SUMMARY OF THE INVENTION

The invention provides a hybrid vehicle in which unnecessary electric power generation for allowing the vehicle to be left unattended is curbed or prevented.

A hybrid vehicle according to one aspect of the invention includes a first power storage device, an electric power generation unit, and a control device. The first power storage device stores electric power for driving the vehicle. The electric power generation unit is configured to charge the first power storage device. The control device is configured to set a target state of charge of the first power storage device, based on a scheduled non-use period for which the hybrid vehicle is scheduled to be left unattended, which period is set by a user, and control the power generation unit so as to adjust the state of charge of the first power storage device to the target state of charge.

The hybrid vehicle may further include a second power storage device, and a converter. The second power storage device stores electric power to be supplied to an auxiliary load of the hybrid vehicle. The converter charges the second power storage device using electric power supplied from the first power storage device. Also, the control device may be configured to, when a given period of time elapses from a point in time at which the hybrid vehicle is initially left unattended, execute charge control where the converter is caused to charge the second power storage device.

The control device may be configured to execute the charge control when the scheduled non-use period is longer than the given period of time.

The electric power generation unit may include an internal combustion engine, and a rotary electric machine configured to generate electric power using driving force of the internal combustion engine. Also, when the control device determines that the hybrid vehicle is left unattended, and acquires the scheduled non-use period set by the user, the control device may be configured to, if a quantity of state indicating a state of charge of the first power storage device is smaller than a quantity of state indicating the target state of charge, execute power generation control where the first power storage device is charged with electric power generated by the rotary electric machine.

The hybrid vehicle may further include a notifying unit configured to inform regarding execution of the power generation control.

The control device may be configured to set the target state of charge to a higher value as the scheduled non-use period is longer. The control device may be configured to execute driving control where the hybrid vehicle is driven while keeping a quantity of state indicating the state of charge of the first power storage device at a quantity of state indicating the target state of charge.

The control device may be configured to set the target state of charge to a predetermined value when the scheduled non-use period is shorter than a predetermined period of time.

According to the above aspect of the invention, the target state of charge of the power storage device is set based on the scheduled non-use period set by the user, and the power generation unit is controlled so as to adjust the state of charge of the power storage device to the target state of charge. In this manner, the amount of electric power charged into the power storage device is determined according to the length of the scheduled non-use period; therefore, the power storage device is less likely or unlikely to be excessively charged. Accordingly, according to the above aspect of the invention, unnecessary power generation for allowing the vehicle to be left unattended can be curbed or prevented.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing the overall configuration of a hybrid vehicle according to one embodiment of the invention;

FIG. 2 is a view showing the configuration of a control device shown in FIG. 1;

FIG. 3 is a functional block diagram related to adjustment control of the control device shown in FIG. 1;

FIG. 4 is a graph showing one example of relationship between a target SOC and a scheduled non-use period;

FIG. 5 is a graph showing one example of relationship between a required SOC and the scheduled non-use period; and

FIG. 6 is a flowchart useful for explaining the procedure of the adjustment control executed by the control device shown in FIG. 1.

### DETAILED DESCRIPTION OF EMBODIMENTS

One embodiment of the invention will be described in detail with reference to the drawings. In the drawings, the same reference numerals are assigned to the same or corresponding components or portions, of which explanation will not be repeated.

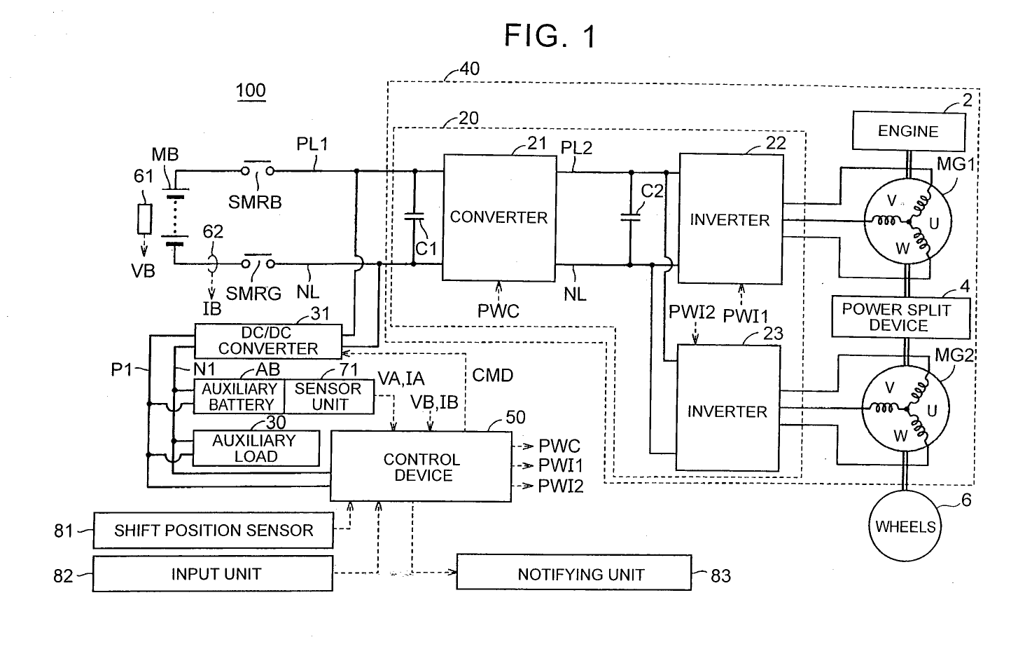

FIG. 1 is a block diagram showing the overall configuration of a hybrid vehicle according to this embodiment of the invention. The hybrid vehicle 100 includes an engine 2, motor-generators MG1, MG2, power split device 4, wheels 6, main battery MB, system main relays SMRB, SMRG, and a PCU (Power Control Unit) 20. The hybrid vehicle 100 further includes an auxiliary battery AB, auxiliary load 30, DC/DC converter 31, control device 50, voltage sensor 61, current sensor 62, and a sensor unit 71. The hybrid vehicle 100 further includes a shift position sensor 81, input unit 82, and a notifying unit 83. The engine 2, power split device 4, motor-generators MG1, MG2, and the PCU 20 constitute a power generation unit 40.

The hybrid vehicle 100 runs, using the engine 2 and the motor-generator MG2 as power sources. Driving force generated by the engine 2 and the motor-generator MG2 is transmitted to the wheels 6.

The engine 2 is an internal combustion engine, such as a gasoline engine or a diesel engine, which delivers power by burning fuel. Operating conditions, such as the throttle opening (intake air amount), fuel supply amount, and the ignition timing, of the engine 2 can be electrically controlled according to signals from the control device 50.

The motor-generators MG1, MG2 are AC rotary electric machines, for example, three-phase AC synchronous motors. The motor-generator MG1 is used as a generator driven by the engine 2, and is also used as a rotary electric machine capable of starting the engine 2. Electric power generated by the motor-generator MG1 can be used for charging the main battery MB, and can also be used for driving the motor-generator MG2. The motor-generator MG2 is mainly used as a rotary electric machine for driving the wheels 6 of the hybrid vehicle 100.

The power split device 4 includes a planetary gear mechanism having three rotary shafts of a sun gear, a carrier, and a ring gear, for example. The sun gear is coupled to a rotary shaft of the motor-generator MG1. The carrier is coupled to a crankshaft of the engine 2. The ring gear is coupled to a drive shaft. The power split device 4 divides the driving force or power of the engine 2 into power to be transmitted to the rotary shaft of the motor-generator MG1, and power to be transmitted to the drive shaft. The drive shaft transmits the driving force to the wheels 6. The drive shaft is also coupled to the rotary shaft of the motor-generator MG2.

The main battery MB is a DC power supply that is rechargeable and dischargeable, and may be in the form of a secondary battery, such as a nickel hydride battery or a lithium-ion battery, or a capacitor. The main battery MB supplies electric power to the PCU 20, and is charged with electric power from the PCU 20 during regeneration of electric power. In other words, the main battery MB is charged by the power generation unit 40. The output voltage of the main battery MB is 201.6V, for example.

The electric power stored in the main battery MB is used for driving the motor-generator MG1 when the engine 2 is started. Therefore, if the electric power stored in the main battery MB is reduced, it becomes difficult to start the engine 2. Also, the electric power stored in the main battery MB can be used for charging the auxiliary battery AB via the DC/DC converter 31.

The system main relays SMRB, SMRG switch between a first position in which the main battery MB is electrically connected to the PCU 20 and the DC/DC converter 31, and a second position in which the main battery MB is electrically disconnected from the PCU 20 and the DC/DC converter 31, according to a signal from the control device 50.

The PCU 20 includes a converter 21, inverters 22, 23, and capacitors C1, C2. The converter 21 performs electric power conversion between a positive line PL1 and a negative line NL, and a positive line PL2 and the negative line NL.

The inverters 22, 23 are connected in parallel with each other, to the positive line PL2 and the negative line NL. The inverter 22 converts DC power supplied from the converter 21 into AC power for driving of the motor-generator MG1, according to a signal PWI1 from the control device 50. The inverter 23 converts DC power supplied from the converter 21 into AC power for driving of the motor-generator MG2, according to a signal PWI2 from the control device 50.

The capacitor C1 is provided between the positive line PL1 and the negative line NL, for reducing fluctuation in voltage between the positive line PL1 and the negative line NL. Also, the capacitor C2 is provided between the positive line PL2 and the negative line NL, for reducing fluctuation in voltage between the positive line PL2 and the negative line NL.

The auxiliary load 30 is electric equipment that operates with electric power supplied from the auxiliary battery AB. The auxiliary battery AB is a power storage element that stores electric power to be supplied to the auxiliary load 30 and the control device 50. The auxiliary battery AB is arranged to deliver a lower voltage than the main battery MB. The output voltage of the auxiliary battery AB is 12V, for example. The auxiliary battery AB is charged by the DC/DC converter 31. Since the auxiliary battery AB supplies electric power for operating the control device 50, it becomes difficult to start the hybrid vehicle 100 if the electric power stored in the auxiliary battery AB is reduced.

The DC/DC converter 31 is arranged to be able to perform bi-directional power conversion between the main battery MB and the auxiliary battery AB. The DC/DC converter 31 operates according to a signal CMD from the control device 50. When the auxiliary battery AB is charged, the DC/DC converter 31 charges the auxiliary battery AB, using electric power supplied from the main battery MB. When the main battery MB is charged, on the other hand, the DC/DC converter 31 charges the main battery MB, using electric power supplied from the auxiliary battery AB.

The voltage sensor 61 detects voltage VB between the terminals of the main battery MB, and outputs the voltage VB to the control device 50. The current sensor 62 detects current IB flowing through the main battery MB, and outputs the current IB to the control device 50. The sensor unit 71 detects voltage VA between the terminals of the auxiliary battery AB and current IA flowing through the auxiliary battery AB, and outputs the voltage VA and the current IA to the control device 50.

The shift position sensor 81 detects the position of a shift lever operated by the driver, and outputs the detected position as a shift position to the control device 50.

The shift lever is arranged to be manually operated to a selected one of parking range “P”, reverse-drive range “R (reverse)”, neutral range “N”, forward-drive range “D (drive)”, and forward-drive brake range “B (brake)”.

When the shift lever is placed in the “P” range, the output shaft of the power split device 4 is locked. In the “R” range, the vehicle is able to run backward. In the “N” range, the vehicle is in a neutral state in which power is inhibited from being transmitted from the output shaft of the power split device 4 to the wheels 6. Namely, the “N” range and the “P” range are non-running (non-drive) ranges. The “D” range and the “B” range are running (drive) ranges in which the vehicle is able to run forward. The “B” range is a shift range in which an engine brake is applied more effectively than that applied in the “D” range.

The input unit 82 is a device with which the user sets a scheduled period of time for which the hybrid vehicle 100 is expected to be left unattended, which period will be called “scheduled non-use period”. The input unit 82 is, for example, a touch panel of a navigation system installed on the hybrid vehicle 100. The user enters the scheduled non-use period by manipulating the touch panel. The input unit 82 outputs a signal indicative of the scheduled non-use period to the control device 50. The scheduled non-use period represents a period of time for which the user plans to park the hybrid vehicle 100. More specifically, the scheduled non-use period represents a period of time from shutdown of the system of the hybrid vehicle 100 to start-up of the system as scheduled by the user.

The notifying unit 83 is a device for notifying the user of execution of electric power generation with engine, which will be described later. The notifying unit 83 receives a signal indicating that electric power is being generated by the engine, from the control device 50, and notifies the user of the information based on the received signal. The notifying unit 83 is, for example, a display device of a navigation system installed on the hybrid vehicle 100.

The input unit 82 and the notifying unit 83 may be a communication device or devices arranged to be able to communicate with a smartphone carried by the user, or the like.

The control device 50 includes a CPU (Central Processing Unit), storage device, and input and output buffers, all of which are not shown in FIG. 1. The control device 50 receives signals from various sensors, etc., and outputs control signals to various devices, so as to control the hybrid vehicle 100 and various devices thereof. The control of the hybrid vehicle 100 and its devices is not limited to processing by software, but may be performed by constructing dedicated hardware (e.g., electronic circuits).

The control device 50 receives the above-indicated voltage VB from the voltage sensor 61, and receives the current IB from the current sensor 62. The control device 50 calculates the SOC indicating the state of charge of the main battery MB, based on the voltage VB and the current IB. The control device 50 receives the voltage VA and the current IA from the sensor unit 71. The control device 50 calculates the SOC indicating the state of charge of the auxiliary battery AB, based on the voltage VA and the current IA.

The control device 50 produces and outputs control signals for controlling the engine 2, PCU 20, and the DC/DC converter 31. The control device 50 operates with electric power supplied from the auxiliary battery AB. During operation of the hybrid vehicle 100, the electric power stored in the auxiliary battery AB is maintained so as not to be reduced. However, in the case where the hybrid vehicle 100 is parked over a long period of time, the electric power stored in the auxiliary battery AB is gradually reduced due to natural discharge, for example.

To deal with the above situation, during parking of the hybrid vehicle 100, the control device 50 performs charge control (which will also be called “pumping charge”) for operating the DC/DC converter 31 to charge the auxiliary battery AB using electric power supplied from the main battery MB, so that the amount of electric power stored in the auxiliary battery AB does not become smaller than the amount required to start the hybrid vehicle 100. For example, each time the parking time lasts a given period of time (e.g., 10 days), the auxiliary battery AB is automatically charged for a given period of time (e.g., 10 min.).

In the above manner, the main battery MB compensates for electric energy that has been discharged from the auxiliary battery AB during parking (e.g., electric energy discharged in 10 days) as needed (for example, by charging the auxiliary battery AB for 10 min.).

However, where electric power stored in the main battery MB is small, it is difficult to charge the auxiliary battery AB through pumping charge. Therefore, if the pumping charge is not performed in the case where the hybrid vehicle 100 is left unattended for a long period of time, the auxiliary battery AB may run out or deteriorate.

To deal with the above situation, it may be proposed to increase the SOC of the main battery MB in advance, when the hybrid vehicle 100 is expected to be left unattended for a long period of time. However, if the SOC of the main battery MB is uniformly increased when the hybrid vehicle 100 is expected to be left unattended for a long period of time, the SOC of the main battery MB may be increased to a higher level than necessary. In this case, the main battery MB is excessively charged, and therefore, the fuel economy of the hybrid vehicle 100 may deteriorate.

Thus, in this embodiment, the control device 50 controls the engine 2 and the motor-generators MG1, MG2, so as to adjust the SOC of the main battery MB to a given value. The given value is set based on the scheduled non-use period for which the hybrid vehicle 100 is scheduled to be left unattended. With this arrangement, the main battery MB is less likely or unlikely to be excessively charged so as to allow the vehicle to be left unattended. Accordingly, otherwise possible deterioration of the fuel economy when the hybrid vehicle 100 is left unattended can be curbed or prevented.

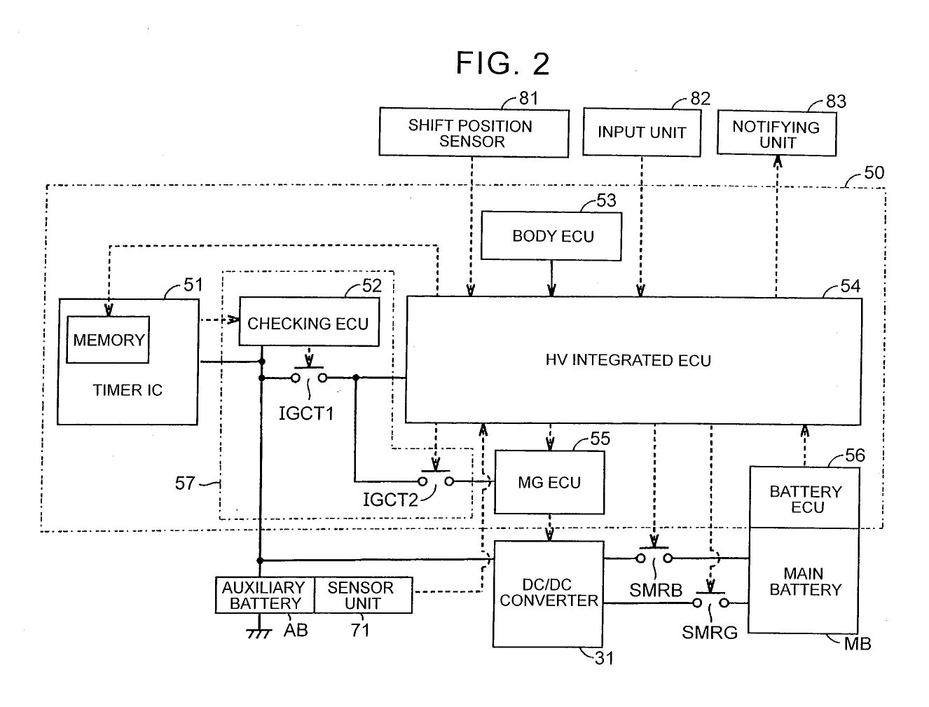

FIG. 2 shows the configuration of the control device 50 shown in FIG. 1 in greater detail. Referring to FIG. 2, the control device 50 includes a timer IC (Integrated Circuit) 51, checking ECU (Electronic Control Unit) 52, body ECU 53, HV integrated ECU 54, MG-ECU 55, battery ECU 56, and switches IGCT1, IGCT2.

The control device 50 is supplied with power-supply voltage from the auxiliary battery AB. The power-supply voltage is constantly supplied to the timer IC 51 and the checking ECU 52, but is supplied to the HV integrated ECU 54 and the MG-ECU 55, via the switches IGCT1 and IGCT2, respectively. The switches IGCT1 and IGCT2 may be mechanical switches like relays, or may use semiconductor devices, such as transistors.

The checking ECU 52 and the switches IGCT1, IGCT2 operate as a power supply controller 57 that controls supply of power-supply voltage to the HV integrated ECU 54 and the MG-ECU 55.

The checking ECU 52 checks if a signal transmitted from a remote key (not shown) carried by the user matches the vehicle. If the result of checking indicates that the remote key matches the vehicle, the checking ECU 52 closes the switch IGCT1 for conduction, so that power is supplied to the HV integrated ECU 54, and the HV integrated ECU 54 is thus started. In this case, the user can move the vehicle by operating various operating parts in the vehicle compartment.

The timer IC 51 outputs a start-up command to the checking ECU 52, when a given time set in a memory incorporated in the timer IC 51 elapses from the time when a system start-up switch (not shown), or the like, is operated so as to bring the vehicle system into an OFF state.

When the checking ECU 52 receives the start-up command from the timer IC 51, it closes the switch IGCT1 for conduction even if no signal is transmitted from the remote key, so that power is supplied to the HV integrated ECU 54, and the HV integrated ECU 54 is thus started.

The body ECU 53 detects vehicle conditions, including conditions of operating parts (such as a start switch) in the vehicle compartment, and transmits the detected vehicle conditions to the HV integrated ECU 54.

The battery ECU 56 monitors the current IB and voltage VB of the main battery MB, detects battery conditions including the state of charge SOC, and transmits the battery conditions to the HV integrated ECU 54.

The HV integrated ECU 54 controls the system main relays SMRB, SMRG, MG-ECU 55, and the engine 2, based on the vehicle conditions transmitted from the body ECU 53, and the battery conditions transmitted from the battery ECU 56.

The MG-ECU 55 controls the DC/DC converter 31, and the inverters 22, 23 and converter 21 shown in FIG. 1, under control of the HV integrated ECU 54.

Thus, the auxiliary battery AB plays an important role as a power supply for control of the vehicle. If the auxiliary battery AB runs out, the vehicle cannot be started. Therefore, if the system of the vehicle that has been parked for a long time is not started, it is necessary to recover electric power stored in the auxiliary battery AB, which has been reduced in quantity due to natural discharge with a lapse of time.

To meet the above need, the HV integrated ECU 54 operates the system main relays SMRB, SMRG, switch IGCT2, and the DC/DC converter 31 so as to carry out pumping charge. More specifically, when a given time elapses from the time when the hybrid vehicle 100 is stopped, the system main relays SMRB, SMRG, and the switch IGCT2, are closed, and the MG-ECU 55 controls the DC/DC converter 31 so as to charge the auxiliary battery AB.

If the schedule non-use period for which the hybrid vehicle 100 is scheduled to be left unattended is entered via the input unit 82, the HV integrated ECU 54 controls the engine 2 and the motor-generators MG1, MG2, so as to perform adjustment control for adjusting the SOC of the main battery MB to a given value. The given value is set based on the scheduled non-use period. The adjustment control will be described in detail.

The configuration of the control device 50 as shown in FIG. 2 is a mere example, and various modifications or changes may be made. While the control device 50 includes several ECUs in FIG. 2, the ECUs may be further integrated into a reduced number of ECUs to constitute the control device 50, or, to the contrary, an increased number of ECUs may constitute the control device 50.

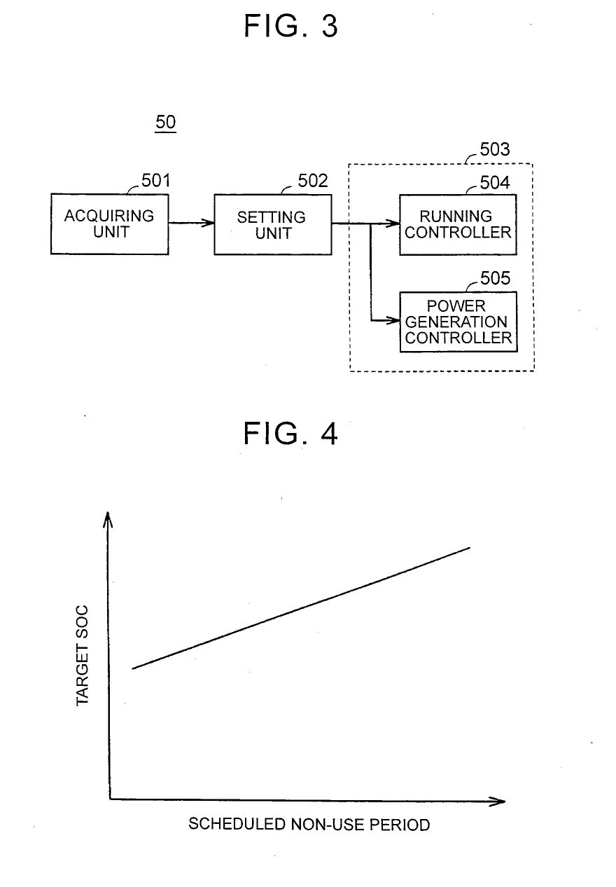

FIG. 3 is a functional block diagram related to the adjustment control of the control device 50 as shown in FIG. 1. Referring to FIG. 3, the control device 50 includes an acquiring unit 501, setting unit 502, and an adjusting unit 503.

The acquiring unit 501 acquires the scheduled non-use period of the hybrid vehicle 100. More specifically, the acquiring unit 501 acquires the scheduled non-use period based on a signal from the input unit 82. The input unit 82 outputs information indicating the scheduled non-use period entered by the user, to the acquiring unit 501.

The setting unit 502 sets a target value of the SOC of the main battery MB based on the scheduled non-use period obtained by the acquiring unit 501. More specifically, the setting unit 502 sets the target value of the SOC of the main battery MB to a higher value as the scheduled non-use period is longer. More specifically, the setting unit 502 is configured to set the target value of the SOC of the main battery MB so that the target value is proportional to the scheduled non-use period.

If the scheduled non-use period is obtained while the hybrid vehicle 100 is running, the setting unit 502 obtains a target SOC by referring to a map indicating the relationship between the target SOC and the scheduled non-use period. FIG. 4 is one example of a map indicating the relationship between the target SOC and the scheduled non-use period. The setting unit 502 sets the obtained target SOC as the target value of the SOC of the main battery MB, and outputs the target value to the adjusting unit 503.

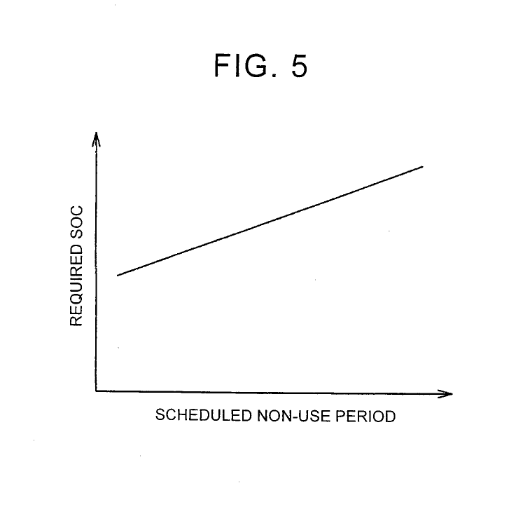

If, on the other hand, the scheduled non-use period is obtained after the hybrid vehicle 100 is stopped, the setting unit 502 obtains a required SOC by referring to a map indicating the relationship between the required SOC and the scheduled non-use period. FIG. 5 is one example of a map indicating the relationship between the required SOC and the scheduled non-use period. The setting unit 502 sets the thus obtained required SOC as the target value of the SOC of the main battery MB, and outputs the target value to the adjusting unit 503.

The adjusting unit 503 controls the engine 2 and the motor-generators MG1, MG2, so as to adjust the SOC of the main battery MB to the target value of the SOC of the main battery MB. The adjusting unit 503 includes a driving controller 504 and a power generation controller 505.

The driving controller 504 performs driving control based on the target SOC received from the setting unit 502. More specifically, when the scheduled non-use period is obtained while the hybrid vehicle 100 is running, the driving controller 504 controls the engine 2 and the motor-generators MG1, MG2 so that the vehicle runs with the engine 2 operated as needed to cause the motor-generator MG1 to generate electric power, so as to keep the SOC of the main battery MB at the target SOC. In other words, under the driving control, the engine 2 and the motor-generators MG1, MG2 are controlled so that the SOC of the main battery MB is kept within a given range having the target SOC as a control center value.

The power generation controller 505 performs power generation control based on the required SOC received from the setting unit 502. More specifically, when the scheduled non-use period is obtained after the hybrid vehicle 100 is stopped, the power generation controller 505 controls the engine 2 and the motor-generator MG1, so that the motor-generator MG1 generates electric power using the driving force of the engine 2, and the main battery MB is charged with the electric power generated by the motor-generator MG1 and supplied to the main battery MB. The power generation as described above will also be called “power generation with engine”.

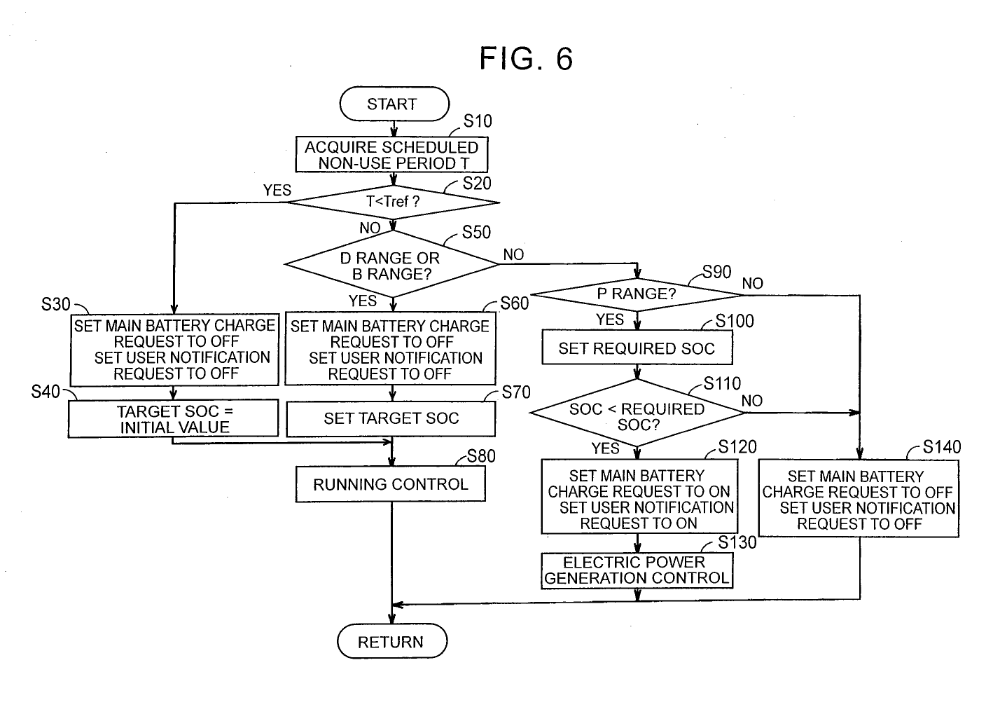

FIG. 6 is a flowchart useful for explaining the procedure of the adjustment control executed by the control device 50 as shown in FIG. 1. Steps in the flowchart shown in FIG. 6 are implemented by calling a program stored in advance in the control device 50 from a main routine, and executing the program at given time intervals or when a given condition or conditions is/are satisfied. The control routine of FIG. 6 may also be implemented by constructing dedicated hardware (e.g., electronic circuits).

Referring to FIG. 6, the control device 50 acquires the scheduled non-use period T for which the hybrid vehicle 100 is scheduled to be left unattended in step S10. More specifically, the control device 50 acquires the scheduled non-use period T based on the output received from the input unit 82.

Then, in step S20, the control device 50 determines whether the scheduled non-use period T is smaller than a threshold value Tref. The threshold value Tref is set to a period of time until the time when the next pumping charge is carried out. Or the threshold value Tref is set to days for which the capacity of the auxiliary batter AB is not undesirably lowered.

If it is determined that the scheduled non-use period T is shorter than the threshold value Tref (YES in step S20), the control device 50 sets a main battery charge request to the OFF state, and sets a user notification request to the OFF state.

The main battery charge request is a request based on which it is determined whether the main battery MB is to be charged with electric power generated using the engine. If the main battery charge request is in the ON state, the main battery MB is charged with electric power generated using the engine. If, on the other hand, the main battery charge request is in the OFF state, the main battery MB is not charged with electric power generated using the engine.

The user notification request is a request based on which it is determined whether the user is to be notified of the fact that the main battery MB is charged with electric power generated using the engine. If the user notification request is in the ON state, the notifying unit 83 displays a message that “In Preparation (Charging) for Long-term Non-use”. With the message thus displayed, the user can be aware of the fact that charging for long-term non-use is being carried out during parking. If the user notification request is in the OFF state, the notifying unit 83 does not display the above message.

Subsequently, in step S40, the control device 50 sets the target SOC to the initial value. Namely, the control device 50 determines that pumping charge is not necessary since the scheduled non-use period is a short period of time, and does not change the target value of the SOC for use in driving control from the initial value as a normal value. In other words, the control device 50 executes pumping charge when the scheduled non-use period is longer than a period of time until the next pumping charge is carried out.

Then, in step S80, the control device 50 performs driving control based on the thus set target SOC. More specifically, the control device 50 controls the engine 2 and the motor-generators MG1, MG2 so that the vehicle runs with the engine 2 operated as needed to cause the motor-generator MG1 to generate electric power, so as to keep the SOC of the main battery MB at the target SOC.

On the other hand, if the scheduled non-use period T is equal to or longer than the threshold value Tref (NO in step S20), the control device 50 determines whether the D range or B range is selected by the user (step S50). Namely, the control device 50 determines whether the hybrid vehicle 100 is running. The control device 50 can acquire the selected range, based on the output from the shift position sensor 81.

If it is determined that the D range or the B range is selected (YES in step S50), the control device 50 sets the main battery charge request to the OFF state, and sets the user notification request to the OFF state (step S60).

Then, in step S70, the control device 50 sets the target SOC based on the scheduled non-use period T. More specifically, the control device 50 sets the target SOC to a higher value as the scheduled non-use period T is longer. Then, the control device 50 proceeds to step S80 to execute driving control.

Thus, when the scheduled non-use period is obtained during running of the hybrid vehicle 100, the driving force of the engine 2 and the motor-generators MG1, MG2 is controlled so that the SOC of the main battery MB becomes substantially equal to the target SOC.

If, on the other hand, it is not determined that the D range or the B range is selected (NO in step S50), the control device 50 determines whether the P range is selected (step S90). Namely, the control device 50 determines whether the hybrid vehicle 100 is being parked. If it is determined that the P range is not selected (NO in step S90), the control device 50 sets the main battery charge request to the OFF state, sets the user notification request to the OFF state, and finishes the adjustment control without charging the main battery MB (step S140).

If it is determined that the P range is selected (YES in step S90), the control device 50 sets the required SOC based on the scheduled non-use period T (step S100). More specifically, the control device 50 sets the required SOC to a higher value as the scheduled non-use period T is longer.

Then, in step S110, the control device 50 determines whether the SOC of the main battery MB is smaller than the required SOC. If it is determined that the SOC of the main battery MB is equal to or larger than the required SOC (NO in step S110), the control device 50 sets the main battery charge request to the OFF state, sets the user notification request to the OFF state, and finishes the adjustment control without charging the main battery MB (S140).

If it is determined that the SOC of the main battery MB is smaller than the required SOC (YES in step S110), the control device 50 sets the main battery charge request to the ON state, and sets the user notification request to the ON state (step S120).

Then, in step S130, the control device 50 performs power generation control. More specifically, the control device 50 controls the engine 2 and the motor-generator MG1 so that the motor-generator MG1 generates electric power, using the driving force of the engine 2, and the main battery MB is charged with electric power generated by and supplied from the motor-generator MG1. During the power generation control, the notifying unit 83 displays the message that “In Preparation (Charging) for Long-term Non-use”.

Thus, when the scheduled non-use period is obtained while the hybrid vehicle 100 is stopped or at rest, electric power generation using the driving force of the engine 2 is carried out so that the SOC of the main battery MB becomes substantially equal to the required SOC.

As described above, in this embodiment, the target state of charge of the main battery MB is set based on the scheduled non-use period set by the user, and the power generation unit 40 is controlled so as to adjust the state of charge of the main battery MB to the target state of charge. Thus, the amount of charge of the main battery MB is determined according to the length of the scheduled non-use period; therefore, the main battery MB is less likely or unlikely to be excessively charged. Thus, according to this embodiment, unnecessary electric power generation for allowing the vehicle to be left unattended can be curbed or prevented.

While the scheduled non-use period of the hybrid vehicle 100 is acquired in the above-described embodiment, a parameter that represents the length of a period for which the vehicle is scheduled to be left unattended may be used, in place of the scheduled non-use period. Also, the quantity of state indicating the state of charge of the main battery MB is not limited to the SOC, but a value, such as a voltage value, based on which the capacity of the battery can be measured may be used.

While the pumping charge is performed in the above-described embodiment, the invention may be applied to the case where the pumping charge is not performed. In this case, the SOC of the main battery MB is increased according to the scheduled non-use period, so as to ensure sufficient electric power for starting the engine 2.

While the invention is applied to the hybrid vehicle on which the engine 2 is installed, in the above-described embodiment, the range of application of this invention is not limited to the hybrid vehicle as described above, but may include a fuel cell car on which a fuel cell is installed in place of the engine 2, and so forth.

In the above-described embodiment, the main battery MB may be regarded as one example of “first power storage device” according to the invention, and the auxiliary battery AB may be regarded as one example of “second power storage device” according to the invention. Also, the engine 2 may be regarded as one example of “internal combustion engine” according to the invention, and the motor-generators MG1, MG2 may be regarded as one example of “rotary electric machines” according to the invention. Also, the DC/DC converter 31 may be regarded as one example of “converter” according to the invention.

It is to be understood that the above-described embodiment is merely exemplary, and does not limit the scope of the invention, and that the scope of the invention includes all modified examples within the range as defined by the appended claims and equivalents thereof.

1. A hybrid vehicle comprising:
a first power storage device in which electric power for driving the vehicle is stored;
an electric power generation unit configured to charge the first power storage device;
a control device configured to set a target state of charge of the first power storage device, based on a scheduled non-use period for which the hybrid vehicle is scheduled to be left unattended, which period is set by a user, and control the power generation unit so as to adjust a state of charge of the first power storage device to the target state of charge;
a second power storage device in which electric power to be supplied to an auxiliary load of the hybrid vehicle is stored; and
a converter that charges the second power storage device using electric power supplied from the first power storage device, wherein
the control device is configured to, when a given period of time elapses from a point in time at which the hybrid vehicle starts being left unattended, execute charge control where the converter is caused to charge the second power storage device.

2. The hybrid vehicle according to claim 1, wherein
the control device is configured to execute the charge control when the scheduled non-use period is longer than the given period of time.

3. The hybrid vehicle according to claim 1, wherein
the control device is configured to operate with electric power supplied from the second power storage device.

4. The hybrid vehicle according to claim 1, wherein:
the electric power generation unit includes an internal combustion engine, and a rotary electric machine configured to generate electric power using driving force of the internal combustion engine; and
when the control device determines that the hybrid vehicle is left unattended, and acquires the scheduled non-use period set by the user, the control device is configured to, when a quantity of state indicating the state of charge of the first power storage device is smaller than a quantity of state indicating the target state of charge, execute power generation control where the first power storage device is charged with electric power generated by the rotary electric machine.

5. The hybrid vehicle according to claim 4, further comprising
a notifying unit configured to inform execution of the power generation control.

6. The hybrid vehicle according to claim 1, wherein
the control device is configured to set the target state of charge to a higher value as the scheduled non-use period is longer.

7. The hybrid vehicle according to claim 1, wherein
the control device is configured to execute driving control where the hybrid vehicle is driven while keeping a quantity of state indicating the state of charge of the first power storage device at a quantity of state indicating the target state of charge.

8. The hybrid vehicle according to claim 1, wherein
the control device is configured to set the target state of charge to a predetermined value when the scheduled non-use period is shorter than a predetermined period of time.
